(19) United States
(12) Patent Application Publication
(10) Pub. No.: US 2024/0332930 A1
(43) Pub. Date: Oct. 3, 2024

(54) ADJUSTMENT ASSEMBLY AND ELECTRICAL APPLIANCE DEVICE WITH SAME

(71) Applicant: SUZHOU MANGSHA TECHNOLOGY CO., Suzhou (CN)

(72) Inventors: Wei ZHOU, Suzhou (CN); Yu ZHANG, Suzhou (CN); Ximing ZHOU, Suzhou (CN)

(21) Appl. No.: 18/738,046

(22) Filed: Jun. 9, 2024

Related U.S. Application Data
(63) Continuation of application No. PCT/CN2023/102361, filed on Jun. 26, 2023.

(30) Foreign Application Priority Data
May 9, 2023 (CN) 202310511709.7

(51) Int. Cl. H02G 3/08

(52) U.S. Cl. CPC H02G 3/081

(57) ABSTRACT

The present disclosure relates to an adjustment assembly and an electrical appliance device with the same. The adjustment assembly includes a supporting frame, a plurality of studs, a pre-buried plate, and a cover plate assembly; a near end of each of the studs is rotatably connected to the supporting frame; far ends of some of the studs resist against the pre-buried plate, and far ends of some of the studs resist against the cover plate assembly; and a distance between the cover plate assembly and/or the pre-buried plate and the supporting plate is adjustable by rotating the studs. By the arrangement of the plurality of studs, heights of the studs relative to the supporting frame are adjusted by rotating the studs, so that the adjustment of the distances from the cover plate assembly and the pre-buried plate to the supporting frame is adjusted.

### TECHNICAL FIELD

The present disclosure relates to the technical field of electrical appliance equipment, and in particular, to an adjustment assembly and an electrical appliance device with the same.

### BACKGROUND

A switch socket refers to a socket into which one or more circuit wires that can be inserted. Through the switch socket, various wires can be inserted. Connection and disconnection of this circuit can be finally achieved by connecting and disconnecting a circuit to and from a copper piece.

At present, electrical appliances such as a switch socket used on walls have the following problems:
(I) An area of a groove on a wall surface needs to be smaller than an area of a panel of an electrical appliance such as a switch socket that is mounted later. When the above-mentioned panel is mounted, the groove on the wall needs to be hidden. Meanwhile, the panel of the switch socket will protrude out of the wall surface. A traditional panel that protrudes out of the wall surface has a large area, with a thickness of at least 4 mm, which makes, so that the panel aesthetically destroys the overall sense of the wall surface and cannot meet the increasing demand for minimalism.
(II) In practical applications, in order to achieve the purpose of making a socket panel and a wall finish surface located on the same horizontal plane, a circle of groove corresponding to a size and thickness of the panel may be formed around a wall opening where the socket panel is mounted, and the socket panel is conventionally mounted. However, this mounting manner is time-consuming and labor-intensive. More importantly, the panel cannot be removed after being mounted. As a result, an electrical module inside cannot be replaced if it is damaged.
(III) The traditional socket panel is fixed with a press type buckle. This fixing manner takes time and labor to subsequently remove or replace the panel, and is not conducive to quick and convenient replacement by users. Therefore, it cannot flexibly satisfy an increasing number of decoration styles.

### SUMMARY

For the shortcomings in the prior art, the present disclosure aims to provide an adjustment assembly and an electrical appliance device with the same, so as to solve one or more issues in the prior art.

In order to achieve the above objectives, the present disclosure adopts the following technical solutions:

Compared with the prior art, the present disclosure has the following beneficial and technical effects:
(I) By the arrangement of the studs, heights of the studs relative to the supporting frame are adjusted by rotating the studs, so that the adjustment of the distances from the cover plate assembly and the pre-buried plate to the supporting frame is adjusted. Lengths of the first protruding parts of the various studs are the same, so that the studs are always at the same level height after being fixed, thereby ensuring the flatness of the cover plate assembly and the pre-buried plate, and avoiding the problem of unevenness. On the other hand, by the arrangement of the spacers, the various spacers have the same or different thicknesses; and the spacers can be used in conjunction with fasteners to achieve fine adjustment of the distance between the pre-buried plate and the supporting plate, and the distance between the cover plate assembly and the supporting plate.
(II) Further, each spacer is provided with the first hole, and the positioning bulge is arranged at the first hole, so that the fastener can be perpendicularly mounted, and it is hard for the fastener to fall off and loosen, thereby ensuring cooperation with the first hole. Meanwhile, the first protruding part is arranged on the outer side of the spacer body, and the splicing seam is provided between the adjacent first protruding parts, so that the adjacent spacers can be quickly separated through the splicing scams.
(III) Further, by the arrangement of a first interface in the cover plate assembly, applications to different situations can be achieved. The first interface can be a socket interface or a hardware interface, or may adopt a brightness display element and a sensor, so that various connection manners are provided to satisfy different types of hardware in different situations.
(IV) Further, the arrangement of the pre-buried plate ensures that a panel is always in the same plane with a wall surface after wall paint is painted. The wall paint around the panel is supported by the pre-buried plate, so unevenness will be avoided. Moreover, the bulge arranged on the pre-buried plate can protect the edge of the orifice of the cover plate mounting hole, so that it is hard to damage the edge of the orifice during the removal of the panel.
(V) Further, the panel is detachably arranged on the cover plate assembly, so that in the disassembling process, the module assembly can be quickly replaced after disassembling the panel, loosening screws, and removing the cover plate assembly.

### BRIEF DESCRIPTION OF THE DRAWINGS

FIG. 1 shows a schematic side view of an adjustment part in an adjustment assembly and an electrical appliance device with the same according to Embodiment I of the present disclosure.

FIG. 2 shows a schematic structural diagram of an adjustment part that is not connected to a pre-buried plate in an adjustment assembly and an electrical appliance device with the same according to Embodiment I of the present disclosure.

FIG. 3 shows a schematic diagram of connection between an adjustment part and an electrical appliance module in an adjustment assembly and an electrical appliance device with the same according to Embodiment I of the present disclosure.

FIG. 4 shows a schematic structural diagram of a supporting frame in an adjustment assembly and an electrical appliance device with the same according to Embodiment I of the present disclosure.

FIG. 5 shows a schematic structural diagram of a stud in an adjustment assembly and an electrical appliance device with the same according to Embodiment I of the present disclosure.

FIG. 6 shows a schematic structural diagram of an adjustment part in an adjustment assembly and an electrical appliance device with the same according to Embodiment II of the present disclosure.

FIG. 7 shows a schematic diagram of a use state of an adjustment part in an adjustment assembly and an electrical appliance device with the same according to Embodiment II of the present disclosure.

FIG. 8 shows a side view of an adjustment part in an adjustment assembly and an electrical appliance device with the same according to Embodiment II of the present disclosure.

FIG. 9 shows a schematic diagram of connection between an adjustment part and an electrical appliance module in an adjustment assembly and an electrical appliance device with the same according to Embodiment II of the present disclosure.

FIG. 10 shows a schematic structural diagram of a front surface of a socket cover plate in an adjustment assembly and an electrical appliance device with the same according to Embodiment I of the present disclosure.

FIG. 11 shows a schematic structural diagram of a back surface of a socket cover plate in an adjustment assembly and an electrical appliance device with the same according to Embodiment I of the present disclosure.

FIG. 12 shows a schematic structural diagram of an adjustment assembly and an electrical appliance structure with the same according to Embodiment I of the present disclosure.

FIG. 13 shows a schematic structural diagram of a panel in an adjustment assembly and an electrical appliance device with the same according to Embodiment I of the present disclosure.

FIG. 14 shows a schematic structural diagram of a pre-buried plate in an adjustment assembly and an electrical appliance device with the same according to Embodiment I of the present disclosure.

FIG. 15 shows a schematic structural diagram of an adjustment assembly and an electrical appliance device with the same according to Embodiment II of the present disclosure.

FIG. 16 shows a schematic structural diagram of an adjustment assembly and an electrical appliance device with the same according to Embodiment III of the present disclosure.

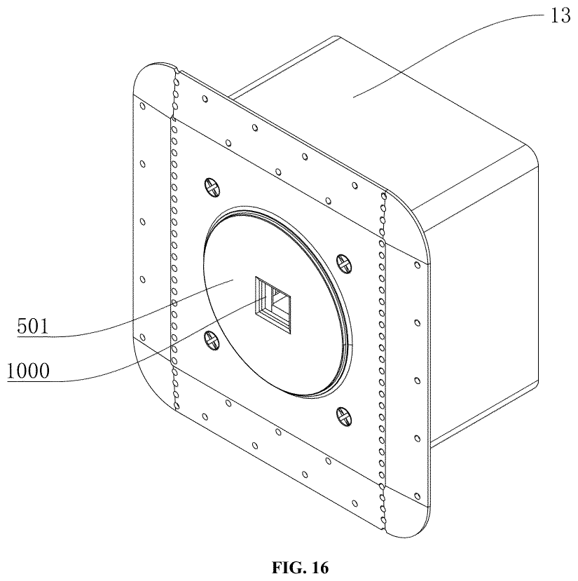

FIG. 17 shows a schematic structural diagram of an adjustment assembly and an electrical appliance device with the same according to Embodiment IV of the present disclosure.

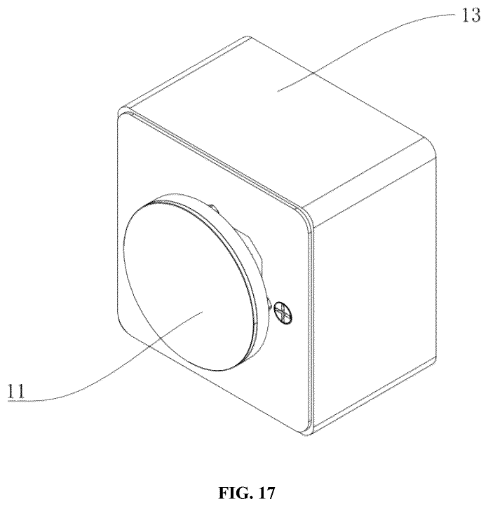

FIG. 18 shows a schematic structural diagram of an adjustment assembly and an electrical appliance device with the same according to Embodiment V of the present disclosure.

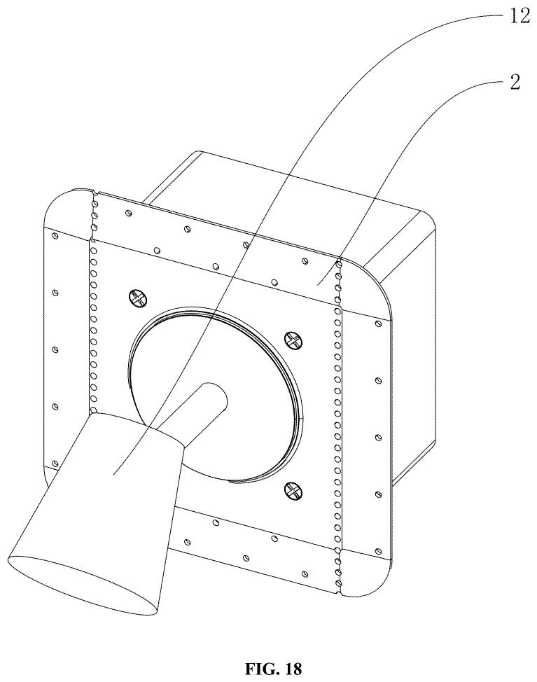

Reference numerals in the drawings: 1: supporting frame; 100: supporting frame body; 101: threaded hole; 102: opening; 103: first positioning hole; 104: guide plate; 2: pre-buried plate; 200: anti-cracking hole; 201: broken line holes; 202: pre-buried plate body; 203: second positioning hole; 204: bulge; 205: cover plate mounting hole; 30: stud; 300: stud body; 301: first hole; 302: first protruding part; 303: external thread; 304: gasket; 31: spacer; 310: spacer body; 311: second hole; 312: second protruding part; 313: positioning bulge; 314: splicing seam; 4: module assembly; 5: cover plate assembly; 500: third hole; 501: cover plate body; 502: first interface; 503: first bayonet; 5030: first part of bayonet; 5031: second part of bayonet; 504: third protruding part; 505: extending part; 506: second bayonet; 6: screw; 7: screw rod; 8: panel; 800: panel body; 801: fourth hole; 802: connecting part; 900: USB interface; 1000: cable interface; 11: sensor; 12: brightness display element; and 13: mounting box.

### DETAILED DESCRIPTION OF THE EMBODIMENTS

In order to make the objectives, technical solutions, and advantages of the present disclosure clearer, a further detailed explanation will be made to an adjustment assembly and an electrical appliance device with the same of the present disclosure below in combination with the accompanying drawings and specific implementations. According to the following explanation, the advantages and features of the present disclosure will be clearer. It should be noted that the accompanying drawings are in a very simplified form and all use imprecise proportions, only to facilitate and explicitly assist the explanation of the implementations of the present disclosure. In order to make the objectives, features, and advantages of the present disclosure more comprehensible, refer to the accompanying drawings. It should be noted that the structure, proportion, size, and the like depicted in the drawings of this specification are only intended to cooperate with the content disclosed in this specification for those familiar with the technology to understand and read, and are not intended to limit the conditions for the implementation of the present disclosure. Therefore, they do not have any technical substantive significance. Without affecting the effects that can be achieved by the present disclosure and purposes that can be achieved, any modification of structures, change of proportion relationships, or adjustment of sizes shall all fall within the scope covered by the technical content disclosed in the present disclosure.

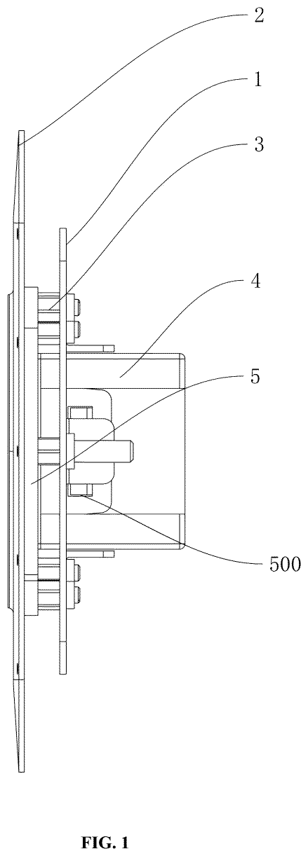

The terms “far end” and “near end” are defined in the present disclosure. Specifically, “far end” represents an end close to a panel, and “near end” represents an end close to a supporting frame. FIG. 1 is taken as an example. A right side of a stud 30 in FIG. 1 is the near end, and a left side of the stud 30 is a far end.

### Embodiment I

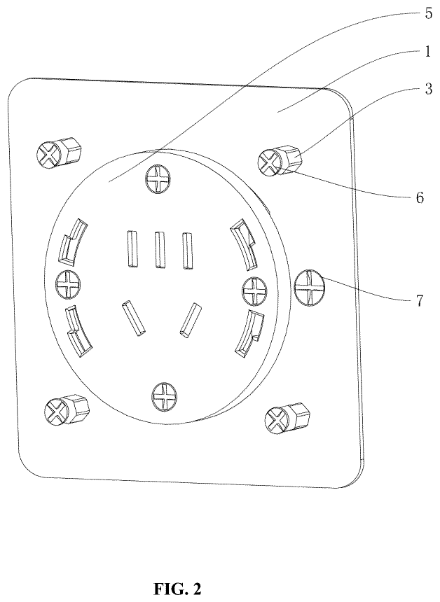

Referring to FIG. 1 and FIG. 2, an adjustment assembly described in this embodiment includes a supporting frame 1, a plurality of studs 30, a pre-buried plate 2, and a cover plate assembly. A near end of each of the studs 30 is rotatably connected to the supporting frame 1. Specifically, the near end of each of the studs 30 is in threaded connection to the supporting frame 1. Far ends of some of the studs 30 resist against the pre-buried plate 2, and far ends of some other studs 30 resist against an inner side of the cover plate assembly 5; and a distance between the cover plate assembly 5 and/or the pre-buried plate 2 and the supporting plate 1 is adjustable by rotating the studs 30.

Specifically, continuing to refer to FIG. 1 and FIG. 2, the distance adjustment includes adjustment of a distance between the cover plate assembly 5 and the supporting frame 1, or adjustment of a distance between the pre-buried plate 2 and the supporting frame 1, thereby achieving adjustment of a relative position between the cover plate assembly 5 and the pre-buried plate 2.

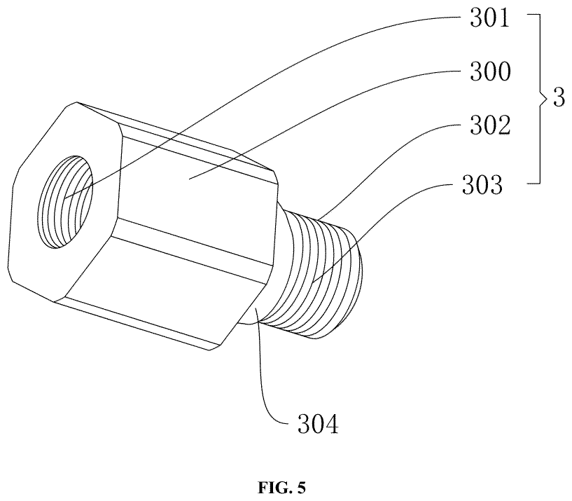

Further, referring to FIG. 5, a specific structure of the stud 30 will be described in detail below:

The stud 30 includes a stud body 300; and a near end of the stud body 300 is provided with a first hole 301. The first hole 301 is preferably an internal thread hole. A far end of the stud body 300 is provided with a first protruding part 302. The first protruding part 302 is preferably columnar, an external thread 303 is formed on an outer side of the first protruding part 302. The stud body 300 is preferably hexagonal. The hexagonal structure is easy for a user to operate, and it is more convenient to rotate the stud body.

Further, continuing to refer to FIG. 5, in the adjustment assembly of Embodiment I, a height of the stud 30 can be adjusted from 5 mm to 60 mm, and the height can be adjusted by 1 mm per turn of the stud 30.

Further, continuing to refer to FIG. 5, in the adjustment assembly of Embodiment I, a gasket 304 sleeves an outer side of the first protruding part 302. A thickness of the gasket 304 is 0.5 mm. The height can be adjusted every 0.5 mm through the gasket, ensuring the accuracy of adjustment of the stud 30.

Further, continuing to refer to FIG. 5, in the adjustment assembly of Embodiment I, an outer diameter of the stud body 300 is greater than an outer diameter of the first protruding part 302.

Of course, in other embodiments of the present disclosure, the stud body 300 can also adopt another shape except the hexagon, such as a quadrangle, an octagon, and a square. The present disclosure will not limit this, as long as it is convenient for the user to operate and the convenience of rotation is improved.

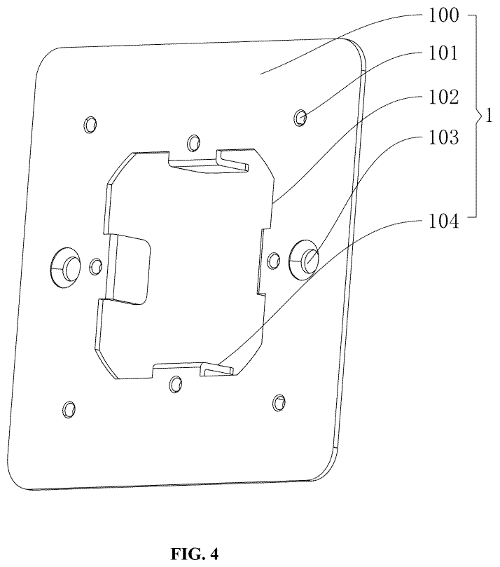

Referring to FIG. 4, a specific structure of the supporting frame 1 will be described in detail below:

The supporting frame 1 includes a supporting frame body 100. Preferably, in the adjustment assembly of Embodiment I, the supporting frame body 100 is preferably square. A first opening 102 is formed in a center of the supporting frame body 100. An opening area of the first opening 102 corresponds to an area of a module assembly 4, so that the module assembly 4 can be matched in the first opening 102. At least two threaded holes 101 and at least one first positioning hole 103 are formed in the supporting frame body 100 around the first opening 102.

Specifically, in the adjustment assembly of Embodiment I, there are eight threaded holes 101. Three threaded holes are formed in each of an upper side and a lower side of the first opening 102, and one threaded hole is formed in each of a left side and a right side of the first opening 102. The first positioning holes 103 are symmetrically formed by taking a center of the first opening 102.

Further, continuing to refer to FIG. 4, an edge of the first opening 102 is provided with at least one guide plate 104. Specifically, in the adjustment assembly of Embodiment I, the first opening 102 is also preferably a square opening. Four edges of the square opening are respectively provided with the guide plates 104, and the guide plates 104 are formed by extending in a direction away from the pre-buried plate 2. Preferably, a width of the guide plate 104 accounts for ½ to ⅓ of an edge of the first opening 102, and the guide plate 104 is located at a center position of the edge of the first opening 102.

Of course, in other embodiments of the present disclosure, the supporting frame body 100 can also be of another shape other than a square, and the first opening 102 can also be of any shape other than a square. The present disclosure will not further limit this, as long as the supporting frame body 100 can be fixedly connected to a mounting box 13 and the first opening 102 can be matched with the module assembly 4.

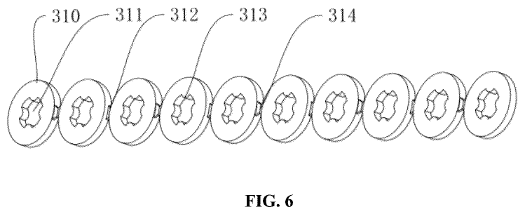

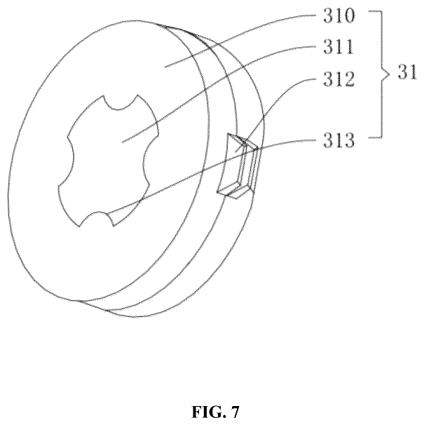

Referring to FIG. 6 and FIG. 7, a specific structure of the cover plate assembly 5 will be described in detail below:

The cover plate assembly 5 is connected to the various studs 30 through fasteners. The cover plate assembly 5 includes a cover plate body 501. In the adjustment assembly of Embodiment I, the cover plate body 501 is preferably circular. At least one third hole 500 and at least one first bayonet 503 are formed in the cover plate body 501, and a surface of the cover plate body 501 is provided with a first interface 502.

Specifically, continuing to refer to FIG. 6 and FIG. 7, in the adjustment assembly of Embodiment I, there are four third holes 500, which are distributed in up, down, left, and right directions of the surface of the cover plate body 501. The first bayonet 503 is configured to be clamped with a panel 8, wherein the first bayonet 503 includes a first part 5030 of bayonet and a second part 5031 of bayonet. An area of the first part 5030 of bayonet is different from an area of the second part 5031 of bayonet. Preferably, in the adjustment assembly of Embodiment I, the area of the first part 5030 of bayonet is smaller than the area of the second part 5031 of bayonet.

Of course, in other embodiments of the present disclosure, the area of the first part 5030 of bayonet can also be larger than the area of the second part 5031 of bayonet, as long as they can be clamped to the panel 8. The present disclosure will not further limit this.

Further, continuing to refer to FIG. 6 and FIG. 7, one side of the cover plate body 501 away from the panel 8, namely, a back surface of the cover plate body 501, is provided with an extending part 505. Specifically, the extending part 505 is connected to a third protruding part 504 arranged on the back surface of the cover plate body 501. The extending part 505 is formed by extending along the side away from the panel 8. At least one second bayonet 506 is formed in the extending part 505. Preferably, the second bayonet 506 is a square bayonet. The second bayonet 506 is configured to be in buckling connection to an outer side of the module assembly 4.

Further, the first interface 502 is preferably a socket interface, wherein the number of interfaces in the socket interface is not limited.

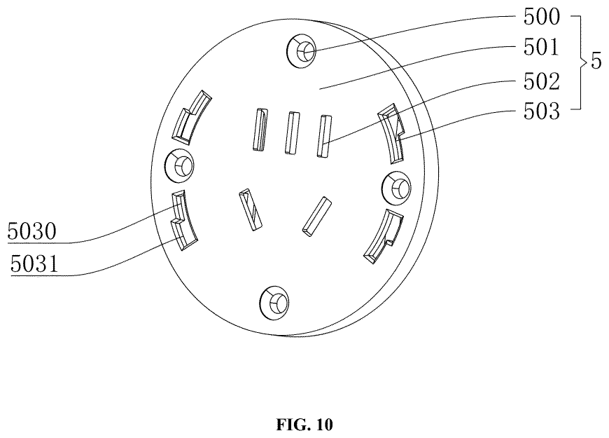

Referring to FIG. 1 and FIG. 10, the pre-buried plate 2 includes a pre-buried plate body 202. Preferably, in the adjustment assembly of Embodiment I, the pre-buried plate body 202 is square. An area of the pre-buried plate body 202 is larger than an area of the supporting frame 1. A cover plate mounting hole 205 for mounting the cover plate assembly and a plurality of second positioning holes 203 are respectively formed in the pre-buried plate body 202, and an edge of an orifice of the cover plate mounting hole 205 is provided with a bulge 204.

Specifically, referring to FIG. 10, the cover plate mounting hole 205 is formed in a center of the pre-buried plate body 202. The cover plate mounting hole 205 is preferably circular, which has the same shape as that of the cover plate assembly 5. Around an outer side of the cover plate mounting hole 205, a second positioning hole 203 is also formed in the pre-buried plate body 202. Fasteners, such as, screws 6, can be connected to the first holes 301 of the studs 30 through the second positioning holes 203, thereby achieving fixing of the pre-buried plate 2 and the studs 30. Continuing to refer to FIG. 10, the above bulge 204 is formed at the far end of the pre-buried plate 2. The bulge 204 is formed around the edge of the cover plate mounting hole 205, and protrudes out of the surface of the pre-buried plate 2. The arrangement of the pre-buried plate 2 ensures that the panel 8 is in the same plane with a wall painting layer after the wall painting layer is painted. Moreover, the bulge 204 arranged on the pre-buried plate 2 can protect the edge of the orifice of the cover plate mounting hole 205, so that it is hard to damage the edge of the orifice during the removal of the panel 8.

Further, a plurality of anti-cracking holes 200 and a plurality of broken line holes 201 are formed in the pre-buried plate body 202. When two or more module assemblies 4 are mounted adjacent to each other, in order to avoid overlapping of the adjacent pre-buried plate bodies 202 in a thickness direction, overlapping regions can be broken and removed according to the broken line holes 201, thereby maintaining coplanarity and continuity between two adjacent pre-buried plate bodies 202. Further, the above-mentioned anti-cracking hole 200 can enlarge an adhesion area of a putty layer and prevent cracking in a later stage.

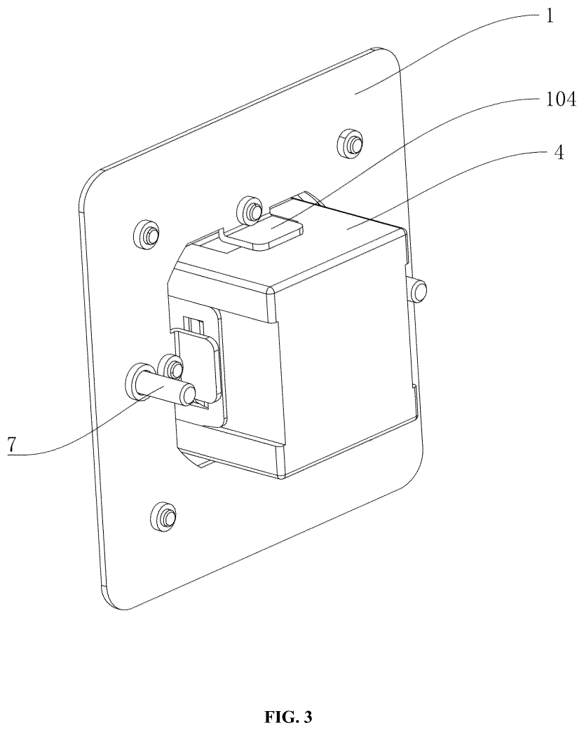

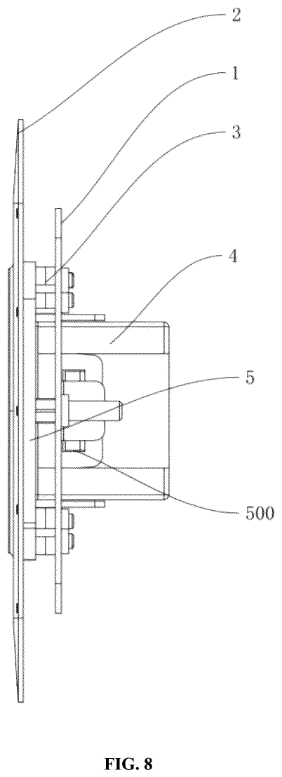

Correspondingly, the present disclosure further provides an electrical appliance device. Referring to FIG. 3 and FIG. 8, the electrical appliance device includes the above-mentioned adjustment assembly and a module assembly 4 connected to the cover plate assembly in the adjustment assembly. Specifically, the module assembly 4 and the cover plate body 501 in the cover plate assembly 5 are connected and fixed through the second bayonet 506 and a buckle. In order to protect the module assembly 4 from being affected by an external environment and play a dust-proof role, a mounting box 13 is arranged on an outer side of the module assembly 4. The mounting box 13 is in threaded connection to a screw rod 7. The screw rod 7 passes through the first positioning hole 103 of the supporting frame 1 and is connected and fixed to a threaded hole inside the mounting box 13, thereby achieving fixing of the mounting box 13 and the supporting frame 1.

Further, continuing to refer to FIG. 3 and FIG. 8, a panel 8 is detachably arranged on the cover plate assembly 5. Specifically, the removal and fixing of the panel 8 are achieved by rotation. That is, when the panel 8 is rotated in a first direction to a certain angle, it is fixed with the cover plate body 501. When the panel 8 is rotated in a second direction opposite to the first direction to a certain angle, it is unlocked with the cover plate body 501. In this embodiment, the first direction can be clockwise, and the second direction can be counterclockwise. Similarly, in other embodiments of the present disclosure, the first direction can also be counterclockwise, and the second direction can be clockwise.

Further, continuing to refer to FIG. 8, in order to achieve full coverage of the panel 8 and the cover plate body 501, a shape of panel 8 is the same as a shape of the cover plate body 501 in the cover plate assembly 5.

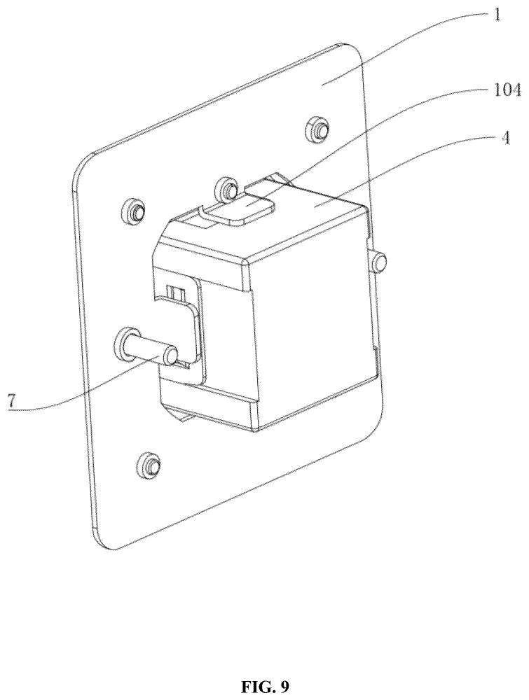

Specifically, referring to FIG. 9, the panel 8 includes a panel body 800, and a surface of the panel body 800 is provided with at least one connecting part 802 that can be connected to the second bayonet 506. The connecting part 802 is hook-shaped and is configured to be clamped with the first bayonet 503. A fourth hole 801 that has the same shape as the first interface 502 is formed in the panel body 800. In the adjustment assembly of Embodiment I, the first interface 502 is preferably a socket interface, and the shape of the fourth hole 801 is matched with the socket interface.

A specific mounting process of the present disclosure is as follows:

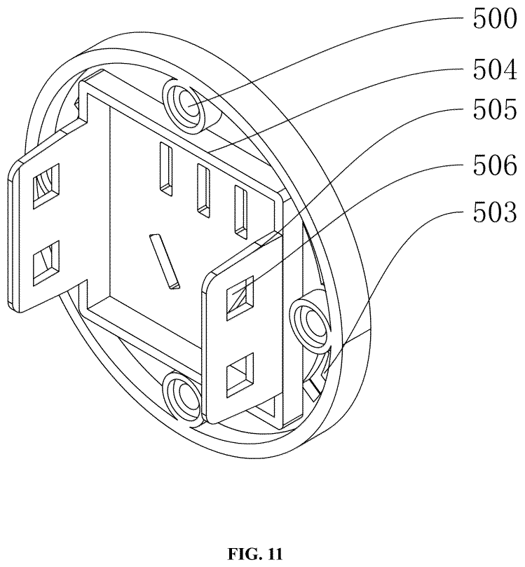

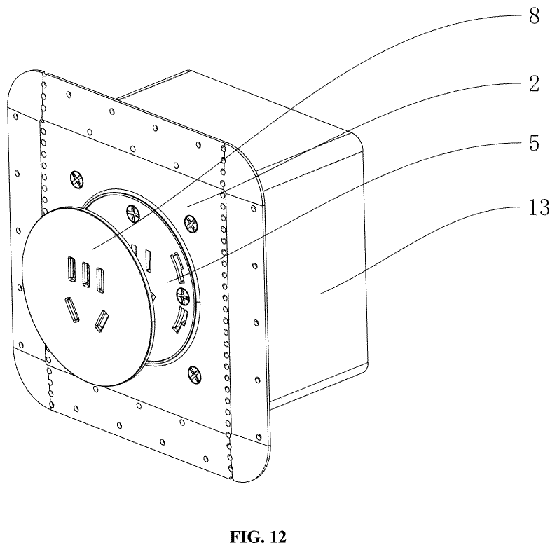

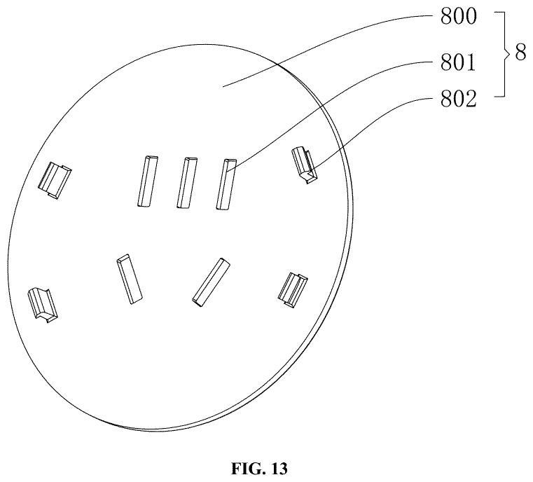

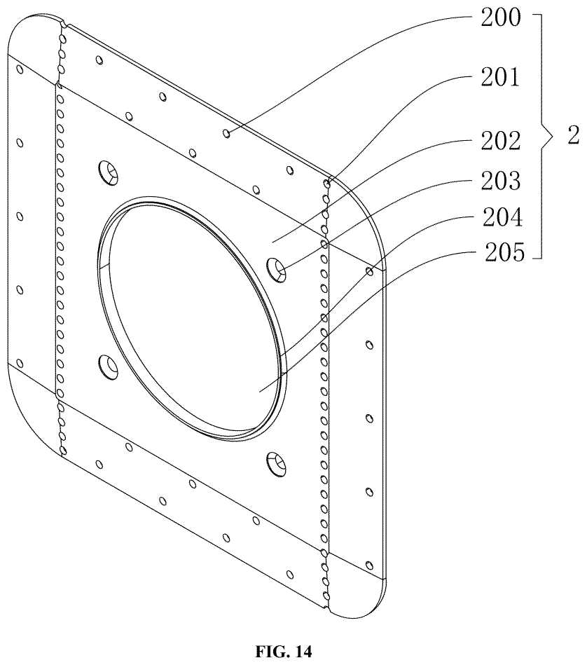

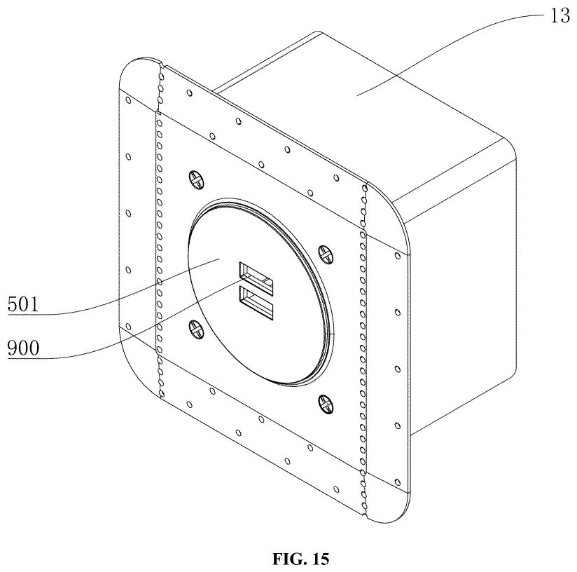

Referring to FIG. 1 to FIG. 5 and FIG. 10 to FIG. 15, before mounting, a distance from a wall surface to a surface of the mounting box 13 is first determined. If the distance from the wall surface to the surface of the mounting box 13 is greater than or equal to 5 mm, a mounting operation can be performed. Otherwise, the mounting operation cannot be completed.

The mounting box 13 is first mounted in a groove of a wall body, and the supporting frame 1 is then connected to the mounting box 13. Specifically, the screw rod 7 passes through the first positioning hole 103 of the supporting frame 1 and is connected to a threaded hole inside the mounting box 13 to fix the position of the supporting frame 1 on the mounting box 13. A layer of thin putty is applied to the wall surface around the groove to increase the adhesion force. After a distance from the supporting frame 1 to a surface to be completed has been measured, some of the studs 30 are mounted on the supporting frame 1, and the studs 30 can be screwed to a fixed stroke through the external threads 303. After the studs 30 are tightened, the distances between upper surfaces of the various studs 30 and the supporting frame 1 are consistent, that is, all the studs 30 are kept at the same level height. If use of ordinary screws cannot guarantee a height or a stroke, the problem of unevenness of the panel will occur during subsequent mounting.

Further, continuing to refer to FIG. 1 to FIG. 9, the first holes 301 on the studs 30 mounted on the supporting frame 1, the screws 6, and the third holes 500 of the cover plate assembly 5 are connected to achieve connection between the cover plate assembly 5 and the supporting frame 1. Meanwhile, the second bayonets 506 of the cover plate assembly 5 are clamped and fixed with the module assembly 4 after passing through the first opening 102, and the module assembly 4 is connected to a wire in the mounting box 13.

Further, continuing to refer to FIG. 1 and FIG. 9, the studs 30 are continued to be mounted on the remaining threaded holes 101 of the supporting frame 1. The studs 30 are in threaded connection to the threaded holes 101 through the external threads 303, and then the pre-buried plate 2 is fixed to the supporting frame 1 through the screws 6. At this time, an anti-cracking net is mounted on a surface of the pre-buried plate 2, and then the panel 8 is fixed ono the cover plate assembly 5. The panel 10 is glued to a handle with a nano adhesive, so that an operator can hold the panel 10 through the handle. Since the cover plate body 501 is provided with the first bayonet 503, clamping to the connecting part 802 of the panel 8 can be achieved through the first bayonet 503. After the panel 8 is rotated clockwise, the connecting part 802 of the panel 8 can be rotated to lock the first part 5030 of bayonet for deadly locking. On the contrary, when the panel 8 is rotated counterclockwise, the connecting part 802 can be rotated to the second part 5031 of bayonet, so that the panel 8 can be unlocked from the cover plate body 501. Finally, after protective paper is applied to the surface of the panel 8, putty can be applied to a surface of the anti-cracking net. After the putty is dried, a wall paint can be applied. After the wall paint is dried, the wall paint is polished with sand paper to expose the protective paper. After the protective paper is torn away, the surface of the panel and a wall surface will be located on the same surface.

### Embodiment II

Most structures of Embodiment II are the same as those of Embodiment I, and a difference is that the adjustment member is preferably a spacer 31. Specifically, referring to FIG. 6, FIG. 7, FIG. 8, and FIG. 9, the spacer 31 includes a spacer body 310. Preferably, in the adjustment assembly and the electrical appliance device in this embodiment, a spacer assembly is composed of eleven spacers 31 arranged in sequence. The spacers 31 have the same or different thicknesses. Further, continuing to refer to FIG. 1 to FIG. 4, when the spacers 31 have different thicknesses, a difference between the thicknesses of adjacent spacers 31 is less than or equal to 0.5 mm. In the adjustment assembly and the electrical appliance device in this embodiment, ten spacers 31 have consistent thicknesses, and the thickness of the eleventh spacer 31 is different from the thicknesses of the other ten spacers 31. Specifically, the thickness of each of the ten spacers 31 is preferably 1 mm, and the thickness of the last spacer 31 is 0.5 mm.

Further, the spacer body 310 is further provided with a second protruding part 312 on an outer side. A splicing seam 314 is provided between joints of the second protruding parts 312 of adjacent spacers 31. The spacer body 310 and the second protruding part 312 are both made of a PC material. Referring to FIG. 2, when the spacers 31 need to be stacked, two adjacent spacers 31 can be separated only by bending the splicing seams 314.

Further, continuing to refer to FIG. 1 to FIG. 4, a second hole 311 is further formed in the spacer 31. The second hole 311 is preferably a round hole. To achieve that a bolt is fixed after being threaded into the second hole 311 and is perpendicularly mounted without easily falling off and being loosened, at least two positioning bulges 313 are arranged along a hole wall of the second hole 311. Specifically, in the adjustment assembly and the electrical application device in this embodiment, there are preferably four arc-shaped positioning bulges 313. An outer diameter formed by outer side edges of the four positioning bulges 313 is slightly greater than an outer diameter of the bolt, so that the positioning bulges can be in clearance fit with the bolt and further position the bolt, to ensure that the bolt is always in contact with the positioning bulges 313 by its outer side and is hard to shake left and right. Of course, in other embodiments of the present disclosure, the second hole 311 may also be in any shape except the round hole, such as a square hole, a round hole, and a triangular hole, as long as the second hole can allow the bolt to pass through.

A specific mounting process of Embodiment II is as follows:

In the adjustment assembly in Embodiment II, by stacking the spacers 31, the distances from the cover plate assembly 5 and the pre-buried plate 2 to the supporting frame 1 are adjustable, so that after a coating layer covers the outer side of the pre-buried plate 2, the spacers 31 adjust the cover plate assembly 5 to be slightly lower than the surface of the pre-buried plate 2. The distance difference between the pre-buried plate 2 and the cover plate assembly 5 is equal to the thickness of the panel 8, so that the panel 8 after mounting and the surface of the coating layer are located on the same plane. Specifically, in a wall surface mounting environment, after the cover plate assembly 5 is connected to the supporting frame 1, the cover plate assembly 5 is also clamped to the module assembly 4. After the module assembly 4 is connected to a wire, the screw 6 is threaded out of the supporting frame 1. The screw is threaded into tail ends of the various spacers 31 that are prepared and is then pressed and tightened. Then, the integrated structure with the supporting frame 1, the module assembly 4, and the cover plate assembly 5 is pushed into the reserved mounting box 13. After the screw is tightened, whether a mounted socket is flush with the wall surface is determined. If a height difference still exists, the above steps are repeated. The spacers 31 are taken out for distance adjustment, thus finally ensuring that the mounted socket is flush with the wall surface.

For example, after being mounted, the cover plate assembly 5 is slightly lower than the surface of the pre-buried plate 2 by 2.79 mm. In this case, three spacers 31 with a thickness of 1 mm are used, namely, a total thickness is 3 mm. In this way, an error is only 0.21 mm. If the cover plate assembly 5 is slightly lower than the surface of the pre-buried plate 2 by 2.75 mm after being mounted, two spacers with a thickness of 1 mm and one spacer with a thickness of 0.5 mm are used at this time, and an error is 0.25 mm. When the adjustment error is kept at or below 0.25 mm, the error between the cover plate assembly 5 and the pre-buried plate 2 can be hardly seen. Of course, in other embodiments of the present disclosure, the spacer 31 may also be designed to have another thickness other than 0.5 mm, such as 0.25 mm and 0.1 mm. The present disclosure will not further limit this.

Further, in Embodiment II, a thickness of the pre-buried plate 2 is preferably 6.5 mm; a thickness of the supporting frame 1 is preferably 1.5 mm. After the mounting is completed, the distance between the pre-buried plate 2 and the supporting frame 1 needs an allowance of 5 mm at least, so that a total thickness of the required spacers 31 may be calculated through the following formula:

$$T = L - 5 + H$$

where T represents the total thickness of the spacers; L represents the distance between the pre-buried plate 2 and the supporting frame 1; and H represents a thickness of the coating layer that is beyond the edge of the pre-buried plate.

Further, in a board mounting environment, a round hole needs to be formed in a board first; a diameter of the round hole is not less than 56 mm. The supporting frame 1, the cover plate assembly 5, and the module assembly 4 are pre-assembled to form a socket assembly. The thickness of the spacer 31 is calculated and obtained by subtracting a thickness of the board by 6.5 mm. Then, the above assembled socket assembly is put into the round hole of the board from the bottom of the board, so that the cover plate body 501 in the cover plate assembly is embedded into the above round hole. Whether a surface of the cover plate body 501 is flush with a surface of the board is observed. If no, the quantity of the spacers 31 needs to be adjusted. When the surface of the cover plate body 501 is flush with the surface of the board, an adhesive tape is adhered to the surface of the cover plate body 501 to avoid displacement caused by subsequent operations. On a back surface of the board, a joint between the supporting frame 1 and the back surface of the board is adhered and fixed by glue. After fixing, the cover plate assembly 5, the module assembly 4, and the spacers 31 are removed. The board with the supporting frame 1 is mounted at a corresponding position. After the cover plate assembly 5, the module assembly 4, and the spacers 31 are mounted again, the panel 8 is finally fixed to the cover plate assembly 5.

### Embodiment III

A difference lies in the structure of the cover plate assembly 5 and the structure of the panel 8. The first interface 502 in the cover plate assembly 5 adopts a hardware interface, specifically a USB interface 900. Therefore, the shape of the fourth hole 801 in the panel 8 corresponds to the shape of the USB interface 900, and an opening size of the fourth hole 801 is also the same as an opening size of the USB interface 900.

### Embodiment IV

Most structures of Embodiment IV are the same as those of Embodiment I, and a difference lies in the structure of the cover plate assembly 5 and the structure of the panel 8. The first interface 502 in the cover plate assembly 5 adopts a hardware interface, specifically a cable interface 1000. Therefore, the shape of the fourth hole 801 in the panel 8 corresponds to the shape of the cable interface, and an opening size of the fourth hole 801 is also the same as an opening size of the cable interface 1000.

### Embodiment V

Most structures of Embodiment V are the same as those of Embodiment I, and a difference lies in the structure of the cover plate assembly 5 and the structure of the panel 8. The first interface 502 in the cover plate assembly 5 is replaced with a sensor 11, specifically preferably, a human presence sensor. However, the panel 8 does not have the fourth hole 801 and adopts a smooth surface design, which covers an outer side of the sensor 11 for protection.

### Embodiment VI

Most structures of Embodiment VI are the same as those of Embodiment I, and a difference is that a brightness display element 12, such as a night lamp, can be added in the cover plate assembly 5. The panel 8 is then covered at a periphery of the cover plate assembly 5, and only the brightness display element 12 is exposed.

The various technical features in the foregoing embodiments may be randomly combined. For concise description, not all possible combinations of the various technical features in the above embodiments are described. However, provided that combinations of these technical features do not conflict with each other, the combinations of the various technical features are considered as falling within the scope of this specification.

The foregoing embodiments merely express several implementations of the present disclosure. The descriptions thereof are relatively specific and detailed, but are not understood as limitations on the scope of the present disclosure. It should be pointed out that a person of ordinary skill in the art can also make several transformations and improvements without departing from the idea of the present disclosure. These transformations and improvements fall within the protection scope of the present disclosure. Therefore, the protection scope of the patent of the present disclosure shall be subject to the appended claims.

What is claimed is:

1. An adjustment assembly, wherein the adjustment assembly comprises a supporting frame, an adjustment member, a pre-buried plate, and a cover plate assembly; a near end of the adjustment member is connected to the supporting frame; a far end of a portion of the adjustment member resists against the pre-buried plate; and a far end of a portion of the adjustment member resists against the cover plate assembly.

2. The adjustment assembly according to claim 1, wherein the adjustment member is a stud; the stud comprises a stud body; a near end of the stud body is provided with a first hole; a far end of the stud body is provided with a first protruding part; an external thread is formed on an outer side of the first protruding part; and a distance between the cover plate assembly and/or the pre-buried plate and the supporting plate is adjustable by rotating the stud.

3. The adjustment assembly according to claim 1, wherein the adjustment member is at least two spacers; the spacers have the same or different thicknesses; a first hole is further formed in each spacer; at least two positioning bulges are further arranged along a hole wall of the first hole; and a distance between the cover plate assembly and/or the pre-buried plate and the supporting plate is adjustable by rotating increasing or decreasing a quantity of the spacers.

4. The adjustment assembly according to claim 2, wherein the stud comprises a stud body; a near end of the stud body is provided with a first hole; a far end of the stud body is provided with a first protruding part; and an external thread is formed on an outer side of the first protruding part.

5. The adjustment assembly according to claim 4, wherein an outer diameter of the stud body is greater than an outer diameter of the first protruding part.

6. The adjustment assembly according to claim 3, wherein when the spacers have different thicknesses, a difference between the thicknesses of adjacent spacers is less than or equal to 0.5 mm.

7. The adjustment assembly according to claim 6, wherein each spacer comprises a spacer body; the spacer body is provided with a second protruding part on an outer side; and a splicing seam is provided between the second protruding parts of adjacent spacers.

8. The adjustment assembly according to claim 1, wherein the supporting frame comprises a supporting frame body; and the supporting frame body has a first opening, at least two threaded holes, and at least one positioning hole.

9. The adjustment assembly according to claim 6, wherein an edge of the first opening is provided with at least one guide plate, and the guide plate is formed by extending in a direction away from the pre-buried plate.

10. The adjustment assembly according to claim 1, wherein the cover plate assembly comprises a cover plate body; at least one second hole and at least one first bayonet are at least formed in the cover plate body; a surface of the cover plate body is provided with any one of an interface, a sensor, a brightness display element, or a switch.

11. The adjustment assembly according to claim 8, wherein a near end of the cover plate body is provided with an extending part, and at least one second bayonet is formed in the extending part.

12. The adjustment assembly according to claim 1, wherein the pre-buried plate comprises a pre-buried plate body; a cover plate mounting hole for mounting of the cover plate assembly and a plurality of positioning holes are respectively formed in the pre-buried body; an edge of an orifice of the cover plate mounting hole is provided with a bulge; and a plurality of anti-cracking holes and a plurality of broken line holes are formed in the pre-buried plate body.

13. An electrical appliance device, wherein the electrical appliance device comprises the adjustment assembly according to claim 1 and a module assembly connected to the cover plate assembly in the adjustment assembly; a mounting box is arranged on an outer side of the module assembly; and the mounting box is fixedly connected to the supporting frame.

14. The electrical appliance device according to claim 13, wherein the electrical appliance device further comprises a panel; the panel is detachably arranged on the cover plate assembly; a shape of the panel is the same as a shape of the cover plate body in the cover plate assembly; the panel comprises a panel body; and a surface of the panel body is provided with at least one connecting part that is connected to the second bayonet, and a plurality of third holes.
